(19) United States
(12) Patent Application Publication
(10) Pub. No.: US 2007/0148581 A1
(43) Pub. Date: Jun. 28, 2007

(54) Photoresist composition and method of forming resist pattern

(75) Inventors: Hiromitsu Tsuji, Kanagawa (JP); Kotaro Endo, Kanagawa (JP)

Correspondence Address: HARNESS, DICKEY & PIERCE, P.L.C., P.O. BOX 828, BLOOMFIELD HILLS, MI, 48303, US

(73) Assignee: Tokyo Ohka Kogyo Co., Ltd, Kanagawa (JP)

(21) Appl. No.: 10/581,777

(22) PCT Filed: Nov. 29, 2004
(86) PCT No.: PCT/JP04/17719

§ 371 Date: Jun. 6, 2006

(30) Foreign Application Priority Data
Dec. 8, 2003 (JP) 2003-409500

(51) Int. Cl. G03C 1/00

(52) U.S. Cl. 430/270.1

(57) ABSTRACT

A photoresist composition is provided, that includes (A) a polymer component including an alkaline-soluble constitutional unit that contains an aliphatic cyclic group having both (i) a fluorine atom or a fluorinated alkyl group and (ii) an alcoholic hydroxide group; in which the alkaline solubility of the polymer component may be changed by action of an acid; and
(B) an acid generating component, capable of generating an acid by way of exposure, that contains at least a sulfonium compound expressed by the general formula (1) below; 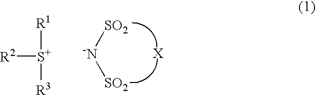
in the formula (1), X represents a C2 to C6 alkylene group of which at least a hydrogen atom is substituted by a fluorine atom; R¹ to R³ represent independently of each other an aryl or alkyl group, and at least one of R¹ to R³ represents an aryl group.

### TECHNICAL FIELD

The present invention relates to photoresist compositions utilized for forming patterns into semiconductor integrated circuits by lithography. Specifically, the present invention relates to photoresist compositions that improve resist properties such as resolution and pattern formability in fine patterning by use of F₂ excimer laser beams in particular, and methods of forming resist patterns using the photoresist compositions. This application is based on and claims the benefit of priority from Japanese Patent Application No. 2003-409500, filed on Dec. 8, 2003, the content of which is incorporated herein by reference.

### BACKGROUND ART

As well-known in the art, in lithography processes, a photoresist layer coated on a laminated semiconductor substrate is irradiated or exposed to optical beams with shorter wave lengths through a mask corresponding to a negative or positive pattern of a semiconductor integrated circuit to be formed. The photoresist compositions, applied to the photoresist layer in the lithographic processes, are typically based on a photosensitive polymer which may be turned alkaline-insoluble (negative) or alkaline-soluble (positive) through an irradiation-induced reaction. After irradiation with patterned beams, the photoresist layer is usually subjected to post-exposure bake (hereinafter sometimes referred to as “PEB”) in order to ensure the irradiation-induced reaction. Next, a developing step may remove soluble portions within the photoresist layer, thereby a layer of photoresist pattern precisely corresponding to the circuit pattern that is to be formed may be produced on the laminated semiconductor substrate. After that, the patterned photoresist layer may optionally be subjected to a post bake so as to be hardened sufficiently to afford durability for the next etching step. In the etching process, the surface layer or upper layer of the laminated semiconductor substrate is dry-etched along the pattern of the photoresist layer using the photoresist layer as a mask.

Since semiconductor integrated circuits are patterned through such processes as described above, photoresist compositions are essentially demanded with the ability to produce fine patterns, namely higher resolution. As such, a positive-type resist composition is proposed that may provide higher resolution and excellent exposure margin with respect to lithography using ArF excimer laser beams (e.g. see Patent Document 1).

In addition, novel technologies have continuously been developed for producing still finer resist patterns. In particular, lithography using F₂ excimer lasers is expected to be a next-generation technology for microfabrication below 65 nm.

Higher resolving ability will be, of course, demanded for photoresist compositions with which next-generation F₂ excimer lasers are utilized as the light source. In order that the resolving ability is higher, “transparency to irradiated light” is required, so that not only the surface portion, but also the bottom portion of the photoresist layer is exposed to the patterned irradiation; thus the resist layer, including the bottom portion, can be sufficiently exposed. That is, the higher the resolving ability involved the higher the transparency of the resist layer to the wavelength of 157 nm which is the main peak of the F₂ excimer laser spectrum.

Accordingly, novel polymers are currently being developed in the art to provide a photoresist composition that assures that it exhibits transparency at 157 nm of the F₂ excimer laser spectrum by means of introducing a fluorine atom (F) into the polymer, and also may provide resist properties such as alkaline-solubility which is an essential characteristic for development properties at the post-exposure stage, resolving ability on pattern transfer, and etching resistance.

Patent Document 1: Japanese Unexamined Patent Application, First Publication No. 2002-341539

The polymers, into which a fluorine atom (F) is being introduced described above, are currently combined with onium salts to thereby prepare resist compositions, in which the anion of the onium salt is a fluorinated alkyl sulfonic acid ion, and the onium salt is an acid generator utilized conventionally in KrF and ArF resist compositions. Such resist compositions and the exposure thereof by use of F₂ excimer lasers may provide finer resist patterns; however, the configuration of the resulting resist patterns is unsatisfactory in that the top portion of the resist patterns is rounded.

In the specification, the term “resolving ability (resolution, resolving power)” means a capacity to form fine patterns, the term “pattern configuration” refers to the configuration of the resulting patterns; thus the meanings of these terms are definitely different from each other. In order to provide a novel resist composition, both the resolving ability and the pattern configuration need to be satisfactory, and thus are essential in the development of resist compositions.

The present invention, based on the above-mentioned example provides a novel article to form fine patterns by use of F₂ excimer laser beams, which had been an unachieved technology as described above. That is, it is an object of the present invention to provide a photoresist composition that has improvements in the configuration of resist patterns while maintaining higher resolving ability, specifically, to provide a photoresist composition that has improved rectangular configuration and film reduction.

### DISCLOSURE OF THE INVENTION

Considerable research has been carried out to solve the problem and it has been found that this can be achieved by combining a specific polymer into which a fluorine atom has been introduced and a specific acid generator.

The present invention is, in the first aspect, a photoresist composition characterized in that it comprises:

(A) a polymer component comprising an alkaline-soluble constitutional unit that contains an aliphatic cyclic group having both of (i) a fluorine atom or a fluorinated alkyl group and (ii) an alcoholic hydroxide group, the alkaline solubility of the polymer component being changeable by action of an acid; and

(B) an acid generating component, capable of generating an acid by way of exposure, that contains at least a sulfonium compound expressed by the general formula (1) below:

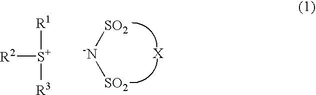

wherein, in the formula (1), X represents a C2 to C6 alkylene group of which at least a hydrogen atom is substituted by a fluorine atom; R¹ to R³ represent, independently of each other, an aryl or alkyl group; and at least one of R¹ to R³ represents an aryl group.

The present invention is, in the second aspect, a method of forming a resist pattern characterized in that it comprises coating the photoresist composition of the first aspect on to a substrate to form a resist film, selectively exposing the resist pattern, then heating and developing the resist film to thereby form a resist pattern.

The descriptions described above and the other objects, features and advantages of the present invention will be explained more specifically in the following.

The present invention may improve defects with respect to rectangular configuration and film reduction which have been deficient in conventional photoresist compositions that contain polymers with fluorine (F) and onium salt of which the anion is a fluorinated alkyl sulfonic acid ion.

### PREFERRED MODE FOR CARRYING OUT THE INVENTION

Preferred modes of the present invention will be explained in the following.

The polymer component (A) (hereinafter sometimes referred to as “component (A)”), which being a base polymer of the photoresist composition according to the present invention, comprises an alkaline-soluble constitutional unit (a1) that contains an aliphatic cyclic group having both of (i) a fluorine atom or a fluorinated alkyl group and (ii) an alcoholic hydroxide group; in which alkaline solubility of the polymer component may be changed by action of an acid. The component may be anything as long as it comprises an alkaline-soluble constitutional unit (a1) that contains an aliphatic cyclic group having both a fluorine atom or a fluorinated alkyl group (i) and an alcoholic hydroxide group (ii), and its alkaline-solubility changing by action of an acid; preferably, it is a positive-type polymer component which increases alkaline-solubility under action of an acid.

The expression “alkaline-solubility changes by action of an acid” refers to a change of the polymer in the irradiated portion. In a case in which the alkaline-solubility increases at the irradiated portion, the polymer may be utilized as a positive-type resist since the irradiated portion turns alkaline soluble. On the other hand, in a case in which the alkaline-solubility decreases at the irradiated portion, the polymer may be utilized as a negative-type resist since the irradiated portion turns alkaline insoluble.

The alkaline-soluble constitutional unit (a1), which contains an aliphatic cyclic group having both a fluorine atom or a fluorinated alkyl group (i) and an alcoholic hydroxide group (ii), may be anything having an aliphatic cyclic group to which is attached an organic group that contains both (i) and (ii).

For example, the aliphatic cyclic group may be a monocyclic or polycyclic hydrocarbon, such as cyclopentane, cyclohexane, bicycloalkane, tricycloalkane and tetracycloalkane, from which one or more hydrogen atoms are detached.

More specifically, examples of the polycyclic hydrocarbons may be a group of polycycloalkanes, such as adamantane, norbornane, tricyclodecane or tetracyclododecane, from which one or more hydrogen atoms are detached. Among them, the groups derived from cyclopentane, cyclohexane and norbornane, from which one or more hydrogen atoms are detached, are industrially preferable.

Examples of the fluorine atom or fluorinated alkyl group (i) described above are a fluorine atom, or lower alkyl groups of which the hydrogen atoms are partly or entirely substituted by fluorine atoms. Specific examples thereof include trifluoromethyl, pentafluoroethyl, heptafluoropropyl and nonafluorobutyl groups. Among these, fluorine atoms and trifluoromethyl are industrially preferable.

The alcoholic hydroxide group (ii) described above may simply be a hydroxyl group, or, alternatively, alkyloxy groups containing an alcoholic hydroxide group, alkyloxyalkyl groups containing an alcoholic hydroxide group or alkyl groups containing an alcoholic hydroxide group, for example, alkyloxy groups, alkyloxyalkyl groups or alkyl groups containing a hydroxyl group. The alkyloxy groups, alkyloxyalkyl groups or alkyl groups may be lower alkyloxy groups, lower alkyloxyalkyl groups or lower alkyl groups respectively.

Specific examples of the lower alkyloxy groups include methyloxy, ethyloxy, propyloxy and butyloxy groups. Specific examples of lower alkyloxyalkyl groups include methyloxymethyl, ethyloxymethyl, propyloxymethyl and butyloxymethyl groups. Specific examples of the lower alkyl groups include methyl, ethyl, propyl and butyl groups.

The alcoholic hydroxide group (ii) described above may be an alkyloxy group containing an alcoholic hydroxide group, alkyloxyalkyl group containing an alcoholic hydroxide group, or alkyl group containing an alcoholic hydroxide group of which the hydrogen atoms within the alkyloxy, alkyloxyalkyl or alkyl group are partially or entirely substituted by fluorine atoms. Preferably, some portions of the hydrogen atoms within the alkyloxy moiety in the alkyloxy group containing an alcoholic hydroxide group or alkyloxyalkyl group containing an alcoholic hydroxide group are substituted by fluorine atoms. Preferably, a portion some of the hydrogen atoms within the alkyl group in the alkyl group containing an alcoholic hydroxide group are substituted by fluorine atoms, thus to form a fluoroalkyloxy group containing an alcoholic hydroxide group, fluoroalkyloxyalkyl group containing an alcoholic hydroxide group, or fluoroalkyl group containing an alcoholic hydroxide group.

Examples of fluoroalkyloxy groups containing an alcoholic hydroxide group include (HO)C(CF₃)₂CH₂O— group, 2-bis(trifluoromethyl)-2-hydroxy-ethyloxy group, (HO)C(CF₃)₂CH₂CH₂O— group, 3-bis(trifluoromethyl)-3-hydroxypropyloxy group and the like. Examples of fluoroalkyloxyalkyl groups containing an alcoholic hydroxide group include (HO)C(CF₃)₂CH₂O—CH₂— group, (HO)C(CF₃)₂CH₂CH₂O—CH₂— group and the like. Examples of fluoroalkyl groups containing an alcoholic hydroxide group include (HO)C(CF₃)₂CH₂— group, 2-bis(trifluoromethyl)-2-hydroxy-ethyl group, (HO)C(CF₃)₂CH₂CH₂— group, 3-bis(trifluoromethyl)-3-hydroxypropyl group and the like.

The groups (i) and (ii) perform well as long as they attach directly to the aliphatic cyclic rings. When the constitutional unit (a1) forms a unit expressed by the general formula (2) below, specifically when an fluoroalkyloxy group containing an alcoholic hydroxide group, fluoroalkyloxyalkyl group containing an alcoholic hydroxide group, or fluoroalkyl group containing an alcoholic hydroxide group is attached to a norbornene ring, then the double bond of the norbornene ring is cleaved to form a unit represented by the general formula (2) shown below, the transparency, alkaline-solubility, and dry-etching resistance are superior, and also such a constitutional unit is preferred from the viewpoint of industrial availability.

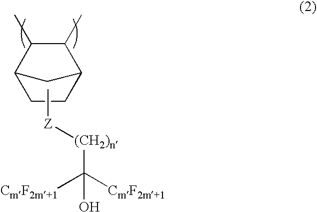

In the general formula (2), Z represents an oxygen atom, oxymethylene group (—O(CH₂)—), or single bond; n′ and m′ represent independently of each other an integer of 1 to 5.

The polymer unit, utilized together with the unit (a1), may be selected from conventional ones without limitation. When it is utilized as a polymer component (A-1) of which the alkaline-solubility increases by action of a positive-type acid, the constitutional unit (a2) derived from a (meth)acrylic ester having a conventional acid-dissociative dissolution-controlling group is preferable in light of higher resolving ability.

Examples of the constitutional unit (a2) are those derived from tert-alkylesters of (meth)acrylic acids such as tert-butyl(meth)acrylate and tert-amyl(meth)acrylate.

The component (A) according to the present invention may be the polymer component (A-2) which comprises a fluorinated alkylene constitutional unit (a3) for increasing the polymer transparency and in which alkaline-solubility increases under action of an acid. The inclusion of the constitutional unit (a3) may further increase the transparency. Preferably, the constitutional unit (a3) is one derived from tetrafluoroethylene.

In the following, general formulas (3) and (4) are shown that represent the polymer components (A-1) and (A-2) respectively.

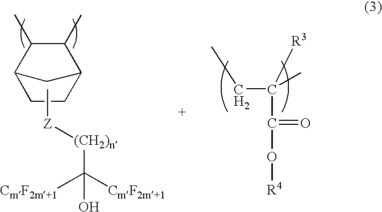

In the general formula (3), Z represents an oxygen atom, oxymethylene group (—O(CH₂)—), or single bond; n′ and m′ represent, independently of each other, an integer of 1 to 5. In the general formula (3), R³ represents a hydrogen atom or methyl group; and R⁴ is an acid-dissociative dissolution-controlling group.

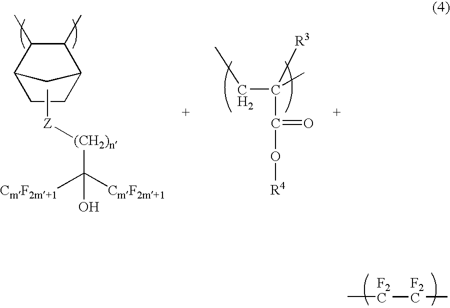

The meanings of Z, n′, m′, R³ and R⁴ in the formula (4) are the same as those in the formula (3).

The polymer component (A-1) and the polymer component (A-2) are expressed by different formulas which include a general formula (2) respectively; however, the polymer component (A-1) and the polymer component (A-2) may be summarized into a concept of polymer components that comprise an alkaline-soluble constitutional unit (a1) that contains an aliphatic cyclic group having (i) a fluorine atom or a fluorinated alkyl group and (ii) an alcoholic hydroxide group, and the alkaline-solubility changes by action of an acid. The polymer components may also have a constitutional unit as shown below.

That is, in the constitutional unit (a1), the fluorine atom or fluorinated alkyl group (i) and the alcoholic hydroxide group (ii) are attached to the aliphatic ring, and the cyclic group thereby constitutes the principal chain.

The fluorine atom or fluorinated alkyl group (i) may be the same as described above, and the alcoholic hydroxide group (ii) may be simply a hydroxyl group.

The component (A) having such a unit may be formed by cyclic polymerization of a diene compound having a hydroxyl group and a fluorine atom. Preferably, the diene compound is heptadiene which easily yields 5- or 6-membered ring polymers which may be excellent in transparency and dry-etching resistant; most preferably from industrial viewpoints, the polymer component is one formed via cyclic polymerization of 1,1,2,3,3-pentafluoro-4-trifluoromethyl-4-hydroxy-1,6-heptadiene (CF₂═CFCF₂C(CF₃) (OH)CH₂CH═CH₂).

When the polymer component is utilized as the positive-type polymer component (A-3) which increases alkaline-solubility by action of an acid, a polymer component is preferable that contains a constitutional unit (a4) of which the hydrogen atom of the alcoholic hydroxyl group is substituted by an acid-dissociative dissolution-controlling group. The acid-dissociative dissolution-controlling group is preferably a chain, branched or cyclic alkyloxymethyl group having a carbon number of 1 to 15 from the viewpoint of proper acid-dissociative property; in particular, lower alkoxymethyl groups such as methoxymethyl group are preferable from the viewpoint of higher resolving ability and superior pattern configuration. The rate of the acid-dissociative dissolution-controlling group is 10 to 40%, preferably 15 to 30% based on entire hydroxyl groups from the viewpoint of excellent pattern-forming ability.

General formula (5) that expresses the polymer component (A-3) is shown below.

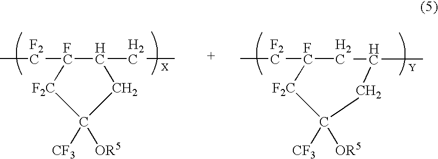

In the general formula (5), R⁵ represents a hydrogen atom or C1 to C15 alkyloxymethyl group; preferably, R⁵ is a methoxymethyl group. X and Y represent mole % of 10 to 50%. A mixture of resins having different ratios in terms of protecting hydrogen atoms on the alcoholic hydroxyl group may be utilized.

Component (A) as described above may be synthesized using a conventional method. The weight average molecular weight of the resin in the component (A) is, but not limited to, preferably 5,000 to 80,000, and more preferably 8,000 to 50,000 based on polystyrene standard by way of GPC.

The component (A) may be formed of one or more resins. Specifically, two or more components selected from (A-1), (A-2), and (A-3) described above may be blended and utilized. The other resins selected from conventional resins for photoresist compositions may be blended and utilized in addition.

The present invention is characterized in that the acid generating component (hereinafter sometimes referred to as “component (B)”) contains a sulfonium compound expressed by the general formula (1) shown below (hereinafter sometimes referred to as “sulfonium compound (I)”).

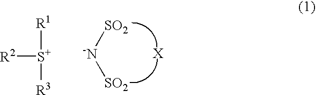

In the general formula (1), X represents a linear or branched alkylene group of which at least a hydrogen atom is substituted by a fluorine atom. The carbon number of the alkylene group is 2 to 6, preferably 3 to 5, and most preferably 3. With a smaller the carbon number of the alkylene group X, the solubility into the resist solvent is higher, and thus is more preferable.

In addition, the higher the number of hydrogen atoms substituted by fluorine atoms in the alkylene group X, the higher the acid strength and this is more preferable since the transparency increases with respect to higher energy irradiation with no more than a 200 nm wavelength or electron beam. The proportion of fluorine atoms in the alkylene or alkyl group, i.e. fluorine content, is preferably 70 to 100%, and more preferably 90 to 100%; most preferably, all of the hydrogen atoms are substituted by fluorine atoms to form a perfluoroalkylene or perfluoroalkyl group.

R¹ to R³ in the general formula (1) represent, independently of each other, an aryl or alkyl group. At least one of R¹ to R³ is an aryl group. Preferably, two or more of R¹ to R³ are aryl groups; most preferably, all of R¹ to R³ are aryl groups. The aryl group of R¹ to R³ may be, for example, selected from aryl groups having a carbon number of 6 to 20 without any particular limitation, more specifically, from phenyl and naphthyl groups which may be substituted or unsubstituted by an alkyl or alkoxy group or halogen atom. From the viewpoint of inexpensive production cost preferably, R¹ to R³ are aryl groups having a carbon number of 6 to 10.

In the general formula (1), the alkyl groups of R¹ to R³ may be selected, for example, from linear, branched or cyclic alkylene groups having a carbon number of 1 to 10 without any particular limitation; preferably, the carbon number is 1 to 5 from the viewpoint of superior resolving ability. Specific examples thereof include methyl, ethyl, n-propyl, isopropyl, n-butyl, isobutyl, n-pentyl, cyclopentyl, hexyl, cyclohexyl, nonyl and dacanyl groups. Among these, methyl groups is preferable from the viewpoint of higher resolving ability and inexpensive production cost. Most preferably, all of R¹ to R³ are all phenyl groups.

In the present invention, the component (B) essentially contains sulfonium compound (I) in order to provide higher resolving ability and superior pattern configuration and to suppress film reduction. The sulfonium compound (I) incorporated into the component (B) may be one or more compounds.

The total content of the compound selected from sulfonium compounds (I) is preferably 25 to 100% by mass, more preferably 30 to 100% by mass based on the entire mass of the component (B). A content of no less than 25% by mass may bring about sufficient effects of the present invention.

In the present invention, the component (B) may contain well known acid generator utilized in chemically amplified resists.

Conventional, various acid generators exist, such as onium salts including iodonium salts and sulfonium salts, oxime sulfonates, bisalkyl or bisaryl sulfonyldiazomethanes, nitrobenzylsulfonates, iminosulfonates and disulfones. The acid generator in the component (B) may be selected from these conventional ones without particular any limitation. Among these, onium salts that contain a fluorinated alkylsulfonic acid ion as its anion (hereinafter referred to as “onium salt-type acid generator”) are preferred since the strength of the generating acid is higher in general. Preferable examples of cations of an onium salt-type acid generator are mono- or di-phenyliodonium, mono-, di- or tri-phenylsulfonium, and dimethyl(4-hydroxynaphthyl)sulfonium, which may be substituted by a lower alkyl group such as methyl, ethyl, propyl, n-butyl, and tert-butyl groups or by lower alkoxy groups such as methoxy and ethoxy groups.

Preferably, from the viewpoint of safety in handling, the anion of the onium salt-type acid generator is a fluorinated alkylsulfonic acid ion of which the alkyl group is linear and its carbon number is 1 to 7, preferably 1 to 3, and its hydrogen atoms are partly or entirely substituted by fluorine atoms. A carbon number of 7 or less may result in higher acid strength as a sulfonic acid.

The fluorinated rate in the fluorinated alkylsulfonic acid ion (content of fluorine atoms in the alkyl group) is preferably 10 to 100%, more preferably 50 to 100%. In particular, alkyl groups of which the hydrogen atoms are entirely substituted by fluorine atoms are preferable from the viewpoint of higher acid strength. Specific examples thereof include trifluoromethane sulfonate and heptafluoropropane sulfonate.

Specific examples of onium salt-type acid generators include trifluoromethane sulfonate or nonafluorobutane sulfonate of diphenyliodonium, trifluoromethane sulfonate or nonafluorobutane sulfonate of bis(4-tert-butylphenyl)iodonium, trifluoromethane sulfonate of trifluorosulfonium, heptafluoropropane sulfonate of triphenylsulfonium or nonafluorobutane sulfonate of triphenylsulfonium, trifluoromethane sulfonate of tri(4-methylphenyl)sulfonium, heptafluoropropane sulfonate of tri(4-methylphenyl)sulfonium, nonafluorobutane sulfonate of tri(4-methylphenyl)sulfonium, trifluoromethane sulfonate of dimethyl(4-hydroxynaphtyl) sulfonium, heptafluoropropane sulfonate of dimethyl(4-hydroxynaphtyl) sulfonium, nonafluorobutane sulfonate of dimethyl(4-hydroxynaphtyl)sulfonium, trifluoromethane sulfonate of monophenyldimethylsulfonium, heptafluoropropane sulfonate of monophenyldimethylsulfonium or nonafluorobutane sulfonate of monophenyldimethylsulfonium, trifluoromethane sulfonate of diphenylmonomethylsulfonium, heptafluoropropane sulfonate of diphenylmonomethylsulfonium or nonafluorobutane sulfonate of diphenylmonomethylsulfonium. These onium salt-type acid generators may be used alone or in combination.

When an onium salt-type acid generator is combined with at least one selected from sulfonium compounds (I) and utilized as the component (B), the content of the onium salt-type acid generator is preferably 10 to 75% by mass, and more preferably 30 to 70% by mass based on the total mass of the component (B). A content in the range of the onium salt-type acid generator may suppress line edge roughness (LER) and development defects. The mixing ratio by mass of (onium salt-type acid generator):(at least one selected from sulfonium compounds) is 1:9 to 9:1, preferably 1:5 to 5:1, and most preferably 1:2 to 2:1. The mixing ratio of the acid generator may also suppress LER and development defects. Furthermore, the term “LER” refers to non-uniform irregularities that are formed after development in resist patterns, for example, in sidewalls with a line and space pattern.

The component (B) is employed at an amount of 0.1 to 30 parts by mass, more preferably 0.5 to 20 parts by mass, and still more preferably 1 to 10 parts by mass based on 100 parts by mass of the component (A). An amount below the lower limit may fail to form images; on the other hand, An amount above 30 parts by mass may lead to a nonhomogeneous solution, thus possibly resulting in poor preservation stability.

The positive-type resist composition according to the present invention may be prepared via dissolving the materials into an organic solvent (C) (hereinafter referred to as “component (C)”). The component (C) may be anything or any solvent that can dissolve the respective ingredients to form a uniform solution, and conventionally, may be any one or more solvents that are selected from a group of known solvents and utilized as solvents for chemically amplified resists.

Specific examples thereof include ketones such as gamma-butyrolactone, acetone, methylethylketone, cyclohexanone, methylisoamylketone and 2-heptanone; polyalcohols such as ethylene glycol, ethylene glycol monoacetate, diethylene glycol, diethylene glycol monoacetate, propylene glycol, propylene glycol monoacetate and dipropylene glycol, and derivatives thereof such as of monomethylether, monoethylether, monopropylether, monobutylether and monophenylether; cyclic ethers such as dioxane; and esters such as methyl lactate, ethyl lactate, methyl acetate, ethyl acetate, butyl acetate, methylpyruvate, ethyl pyruvate, methyl methoxypropionate and ethyl ethoxypropionate. These organic solvents may be used alone or in combination.

There is no set limit on the amount of solvent used; the amount is adjusted so as to make it possible to coat the resist composition onto substrates and the like; in general, the solid content of the resist composition is 2 to 20% by mass, preferably 5 to 15% by mass.

In order to enhance post exposure stability of latent images formed by pattern wise exposure of resist layers, a nitrogen-containing organic compound (hereinafter referred to as component (D)) may be optionally incorporated into the positive-type resist compositions according to the present invention. The component (D) may be selected from various compounds proposed in the art, preferably amines, in particular secondary aliphatic amines or tertiary aliphatic amines.

The aliphatic amines refer to amines of alkyl or alkylalcohol having a carbon number of 15 or less; examples of the secondary or tertiary amines include trimethylamine, diethylamine, triethylamine, di-n-propylamine, tri-n-propylamine, tripentylamine, trihexylamine, triheptylamine, trioctylamine, tridecanylamine, tridodecylamine, tritetradecanylamine, diethanolamine, triethanolamine, and triisopropanolamine; in particular, tertiary alkanolamine such as triethanolamine and triisopropanolamine are preferable. These may be used alone or in combination. The component (D) is used in an amount of 0.01 to 5.0 parts by mass, for 100 parts by mass of the component (A).

In order to prevent sensitivity degradation due to the component (D), to improve configuration of resist patterns, and to enhance post exposure stability of latent images formed by pattern wise exposure of resist layers, an organic carboxylic acid or phosphorous oxo acid or derivative thereof (E) (hereinafter referred to as component (E)) may be additionally incorporated as an optional component. Furthermore components (D) and (E) may be utilized alone or in combination.

Preferable examples of organic carboxylic acids include malonic acid, citric acid, malic acid, succinic acid, benzoic acid and salicylic acid.

The phosphorous oxo acid or derivative thereof may be phosphoric acid and its derivatives, e.g. esters such as phosphoric acid, di-n-butylphosphate and diphenylphosphate; phosphonic acid and its derivatives, e.g. esters such as phosphonic acid, dimethylphosphonate, di-n-butylphosphonate, phenylphosphonic acid, diphenylphosphonate and dibenzylphosphonate; phosphinic acid and its derivatives, e.g. esters such as phosphinic acid and phenylphosphinate. Among these, salicylic acid and phenylphosphonic acid are preferable in particular.

The component (E) is utilized at a proportion of 0.01 to 5.0 parts by mass, for 100 parts by mass of component (A).

In addition, a dissolution-controlling agent may be incorporated. Specifically, such compounds may be exemplified by lower molecular weight phenol, alcohol or carboxylic acid compounds preferably having a molecular weight of 100 to 500, in which at least one fluorine atom is attached to the compound and its solubility in alkaline developer increases by action of an acid, or alternatively a portion of hydrogen atoms of hydroxyl groups within the phenol, alcohol or carboxylic acid compounds is substituted by an acid-unstable substituent capable of controlling alkaline-solubility (acid-dissociative dissolution-controlling group).

Examples of the acid-dissociative substituents include tertiary alkyl, tertiary alkoxycarbonyl, tertiary alkoxycarbonylalkyl, and chain or cyclic alkoxyalkyl groups.

Specific examples thereof include tertiary alkyl groups such as tert-butyl group; tertiary alkoxycarbonyl groups such as tert-butoxycarbonyl group; tertiary alkoxycarbonylalkyl groups; chain, branched or cyclic alkyloxymethyl groups having a carbon number of 1 to 15 such as methoxymethyl, tert-amyloxymethyl and 4-tert-butyl-cyclohexyloxymethyl groups.

Such compounds may be expressed by the general formulas (8) and (9), for example.

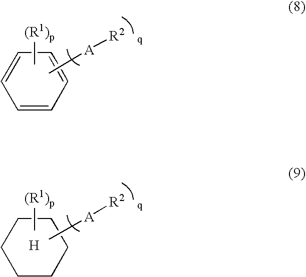

In the chemical formulas (8) and (9), R¹ represents a hydrogen atom, alkyl group, alkoxy group or fluorine atom; R² represents an acid-dissociative dissolution-controlling group; A is —C(CₙF₂ₙ₊₁)—, —(CₘF₂ₘ₊₁)—O—CO—O—, —(CₘF₂ₘ₊₁)—O—, or —O—CO—O—; n, m, p and q are independent of each other and are integers of 1 to 4, with a proviso that R¹ is a fluorine atom when A is —O—CO—O—.

More specific examples of compounds expressed by these formulas may be the compounds expressed by the chemical formulas (10) to (15) below.

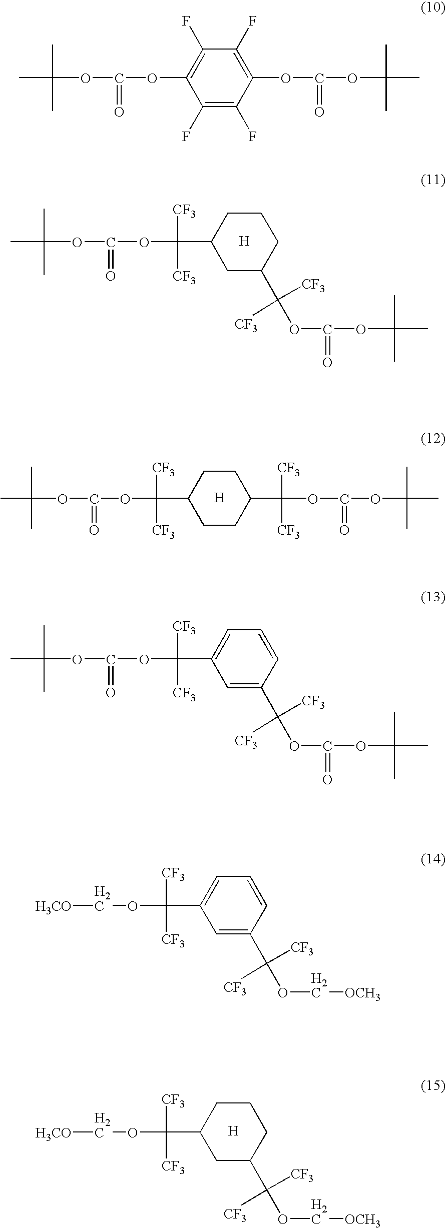

Examples of the other compounds include 3,3′,5,5′-tetrafluoro[(1,1′-biphenyl)-4,4′-di-t-butoxycarbonyl], 4,4′-[2,2,2-trifluoro-1-(trifluoromethyl)ethylidene]bisphenol-4,4′-di-t-butoxycarbonyl, 2-trifluoromethylbenzenecarboxylic acid1,1-t-butylester, and 2-trifluoromethylcyclohexane carboxylic acid-t-butylester.

Among these, the compounds expressed by the chemical formulas (10) to (15) are preferable since they provide higher transparency and superior rectangular shape in fine patterns.

Preferably, the acid-dissociative dissolution-controlling group R² is a chain, linear or cyclic alkyloxymethyl or tertiary alkyl group having a carbon number of 1 to 15. Among others, R² is preferably the compounds expressed by the chemical formulas (13) or (14).

The amount of the dissolution-controlling agent in the photoresist composition according to the present invention is 2 to 30 parts by mass, and preferably 3 to 10 parts by mass for 100 parts by mass of the main component polymer (A). When the amount is less than 2 parts by mass, the dissolution-controlling effect is minor, and when the amount is above 30 parts by mass, the thermal resistance of the resist is likely to be insufficient.

When a fluorine atom is incorporated into the dissolution-controlling agent, transparency for 157 nm wavelength light is significantly enhanced and resolving ability is improved.

The photoresist composition according to the present invention may further contain miscible additives such as additional resins to improve the properties of resist films, surfactants to upgrade the coating properties, and dissolution-controlling agents, plasticizers, stabilizers, colorants, halation-inhibiting agents and the like if desired.

The method of forming resist patterns according to the present invention may be carried out by forming resist patterns through a conventional lithography process using the photoresist composition described above. In the method, the photoresist composition is coated on to a substrate, for example, by way of rotary coating, and then dried to form a resist film. Then the resist film is selectively exposed through a mask pattern and then heated after the exposure. Finally, the film is developed using an alkaline solution to form a resist pattern, and then is subjected to post baking if necessary. The irradiation source is preferably F₂ excimer laser beams.

Various substrates such as organic or inorganic anti-reflective films, SiON, SiN, Si₃N₄ and the like, having various films thereon, may be utilized as the substrate. The wavelength of the irradiation beam is not particularly limited; the irradiation source may be ArF excimer lasers, KrF excimer lasers, F₂ excimer lasers, EUV (extreme ultraviolet), VUV (vacuum ultraviolet), EB (electron beam), X-ray, soft X-ray, and the like. The resist compositions according to the present invention may be effectively employed together with F₂ excimer lasers.

### EXAMPLES

Below, the present invention will be explained in detail by way of examples, which are merely for properly illustrating the invention, and do not limit the present invention in any way.

### Example 1

100 parts of the fluorine-containing polymer (expressed by the previously described general formula (5), with 20% of R⁵ being protected by a methoxymethyl group, and X:Y=50:50 in mole ratio), 5 parts by mass of the acid generator expressed by the chemical formula (16) below, 0.1 parts by mass of triethanolamine, and 0.1 parts by mass of salicylic acid were added into and mixed together with 1300 parts by mass of propyleneglycol monomethylether acetate to prepare a photoresist composition.

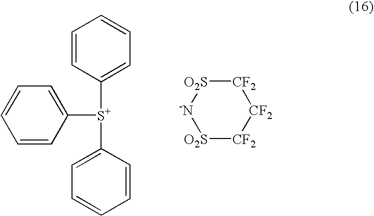

A silicon wafer having a SiON thin film was employed as a substrate on which a resist film was formed. The photoresist composition described above was coated on to the substrate uniformly by spin coating, and then heated to dry at 90 degrees C. for 90 seconds, to thereby prepare a resist film 180 nm thick.

The resist film was exposed selectively through a mask by F₂ excimer lasers (157 nm wavelength) using F₂ excimer lasers irradiation system (by Exitech Co., NA=0.85, ½ zone).

After the selective exposure, the resist film was heated at 120 degrees C. for 90 seconds, then was developed in a solution containing 2.38% by weight of tetramethylammonium hydroxide; the developing temperature was 23 degrees C. and the developing period was 60 seconds. After development, the specimen was rinsed with de-ionized water and dried.

Observation by use of a scanning electron microscope (SEM) confirmed that a line and space (1:1.5) in 200 nm pitch (line: 80 nm, space: 120 nm) was formed on the substrate. The sensitivity at that time was 24.6 mJ/cm². From the observation of the cross-section configuration, the line of the pattern clearly exhibited a rectangular shape, and no film reduction was observed.

### Comparative Example 1

A pattern was formed in the same manner as Example 1, except that 5.0 parts by mass of triphenylsulfonium-nonafluorobutane-sulfonate was used in place of the acid generator expressed by the formula (16) shown above.

Observation by use of a scanning electron microscope (SEM) showed that a pattern was formed on the substrate with line and space (1:1.5) of 200 nm pitch (line: 80 nm, space: 120 nm), the top of the resist pattern was rounded, and the film reduction appeared. The sensitivity at that time was 12.0 mJ/cm².

### INDUSTRIAL APPLICABILITY

As explained above, the photoresist compositions and the methods of forming a resist pattern according to the present invention are available for patterning of semiconductor integrated circuits by lithography, and in particular are effective for fine patterning by use of F₂ excimer laser beams.

1. A photoresist composition comprising:
(A) a polymer component comprising an alkaline-soluble constitutional unit that contains an aliphatic cyclic group having both (i) a fluorine atom or a fluorinated alkyl group and (ii) an alcoholic hydroxide group, the alkaline solubility of the polymer component being changeable by action of an acid; and
(B) an acid generating component, capable of generating an acid by way of exposure, that contains at least a sulfonium compound expressed by the general formula (1) below: 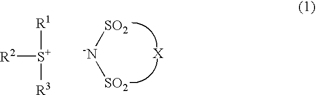
wherein, in the formula (1), X represents a C2 to C6 alkylene group of which at least a hydrogen atom is substituted by fluorine atom; R¹ to R³ represent, independently of each other, an aryl or alkyl group; and at least one of R¹ to R³ represents an aryl group.

2. A photoresist composition according to claim 1, further comprising a nitrogen-containing organic compound.

3. A photoresist composition according to claim 1, further comprising an organic carboxylic acid, or a phosphorous oxo acid or derivative thereof.

4. A method of forming a resist pattern, comprising:
coating the photoresist composition according to claim 1 on a substrate to form a resist film,
selectively exposing the resist film, and
heating and developing the resist film after exposure to form a resist pattern.

5. A method of forming a resist pattern according to claim 4, wherein a SiON film is provided on the substrate.
